(19) United States
(12) Patent Application Publication
(10) Pub. No.: US 2016/0001102 A1
(43) Pub. Date: Jan. 7, 2016

(54) Structure and Method For Recognizing Information on a Filter Installed in an Air Purifier of a Respirator

(71) Applicant: OTOS Wing Co., Ltd., Seoul (KR)

(72) Inventor: Moon-Young HUH, Seoul (KR)

(73) Assignee: OTOS Wing Co., Ltd., Seoul (KR)

(21) Appl. No.: 14/754,832

(22) Filed: Jun. 30, 2015

(30) Foreign Application Priority Data
Jul. 2, 2014 (KR) 10-2014-0082490

(51) Int. Cl. A62B 9/00; A62B 7/10; A62B 18/02

(52) U.S. Cl. CPC A62B 9/006; A62B 18/02; A62B 7/10

(57) ABSTRACT

Provided is a method of recognizing information on a filter unit mounted on an air purifier of a respirator wherein the air purifier and the filter unit of the respirator which filters polluted external air and supplies purified air to a worker are wirelessly interconnected such that a control unit of the air purifier may provide the worker with information on the filter unit such as a type, a load rate depending on a blockage degree of the filter unit, a final operation time, a residual operation time, and a replacement time of the filter unit through information data transmitted from the filter unit. It is possible to precisely recognize the filter unit appropriate for a workplace and a work environment, thereby preventing an error, failure, and malfunction of the filter unit and simultaneously with continuously working. The air purifier and the filter unit are wirelessly interconnected through radio frequency identification (RFID), wireless fidelity (Wi-Fi), near field communication (NFC), Bluetooth, or Zigbee to detect a type of a filter, recognize information of the detected filter such as an operation time and life thereof by counting an operation time of the filter, and allow a wearer to recognize the information.

### CROSS-REFERENCE TO RELATED APPLICATION

This application claims priority to and the benefit of Korean Patent Application No. 2014-0082490, filed on Jul. 2, 2014, the disclosure of which is incorporated herein by reference in its entirety.

### BACKGROUND

1. Field of the Invention

The present invention relates to an air purifier of a respirator, and more particularly, to a structure and method for recognizing information on a filter unit installed in an air purifier of a respirator which filters polluted external air and supplies purified air to a worker who works in an extreme environment, in which the air purifier is wirelessly connected to the filter unit to provide the worker with information such as a type, operation time, and replacement time of the filter unit.

2. Discussion of Related Art

Generally, respirators applied to hard hats, used while welding, applied to face shields, and used against asbestos are products used in various industrial fields in extreme environments such as welding, construction, and civil engineering to prevent safety accidents which may occur while workers are working.

Such respirators applied to hard hats, used while welding, applied to face shields, and used against asbestos, which are placed on heads of workers who are working in extreme environments, include air purifiers which purify polluted external air and supply purified air to wearer thereof in workplaces where harmful particles, fumes, and harmful odors occur and places where infectious diseases occur.

Such respirators are applied to hard hats, used while welding, applied to face shields, and used against asbestos. Here, respirators applied to hard harts are used in workplaces for welding, grinding, and sanding. Respirators used while welding are applied to workplaces for welding and grinding. Respirators applied to face shields are used while grinding, sanding, coating, and crop-dusting and used in pharmaceutical laboratories, places where general particles are generated, and places where infectious diseases occur. Also, respirators used against asbestos are used in places where asbestine particles, harmful dust particles, other contaminants, and infectious pathogens occur. Such respirators purify polluted air such as harmful dust particles, harmful odors and stench, which occur in workplaces and supply purified air to workers and wearers.

Here, such air purifiers are connected to respirators through air supply tubes, filter polluted external air, and supply purified air to respirators placed on heads of wearers, thereby allowing workers to easily work in enclosed spaces and spaces at a high temperature.

Meanwhile, FIGS. 1 and 2 illustrate an air purifier 50 connected to a respirator mask 20 through an air supply tube 30. The air purifier 50 includes a body 51 having an installation space 51a therein, a filter unit 53 detachably installed in the installation space 51a of the body 51 to filter and purify the polluted air supplied from the outside, and a blower (not shown) for supplying the purified air filtered by the filter unit 53 to the respirator mask 20 through the air supply tube 30.

Here, the filter unit 53 includes a particle removal filter or an odor removal filter. The particle removal filter is a high-efficiency filter having an average purification rate of its own capable of filtering out particles having a size of about 0.3 p, in which it is possible to allow the air to pass and to filter out 99.9% of various polluted materials, agricultural pesticides, fine dust, and infectious pathogens. The odor removal filter has an excellent deodorizing force to filter out harmful elements such as odors and stench passing through the particle removal filter.

Here, the filter unit 53 further includes a pre-filter (not shown) and wire mesh (not shown). When the filter unit 53 is installed in the installation space 51a in the body 51, a filter cover 54 which fixes the filter unit 53 and includes an inlet hole 54a to allow external air to flow therein is provided.

Due to this, the filter unit 53 including one of the odor removal filter and the particle removal filter is inserted and installed in the installation space 51a formed in the body 51 of the air purifier 50, the pre-filter is provided outside the filter unit 53, the wire mesh is provided outside the pre-filter, and the filter cover 54 is provided outside the wire mesh while being detachably and fixedly installed in front of the body 51.

With the structure described above, polluted external air flows into the air purifier 50 through the inlet hole 54a of the filter cover 54 fixedly installed in front of the body 51. The polluted external air flowing through the filter cover 54 is supplied to the pre-filter through the wire mesh to be filtered. The air filtered by the pre-filter is supplied to the filter unit 53 formed of one of the particle removal filter and the odor removal filter to be filtered and purified. The purified air, according to the driving of the blower, is supplied to the respirator mask 20 through the air supply tube 30. Also, a supply amount of the air is controlled for each level according to the need of a wearer.

Here, a control unit (not shown) which controls a state of the filter unit 53 and various sensors is provided in the air purifier 50. A switch input unit, whose reference numeral is not shown in the drawings, which inputs an operation command such as a temperature, an air flow volume, an oxygen amount, power on/off, etc., and a liquid crystal display (LCD) panel 57 which displays various data values and the state of the filter unit 53 are provided on a top surface of the air purifier 50.

Meanwhile, the air purifier 50 has a structure which is simple and easy to be carried on the waist of the wearer using a belt, a shoulder strap, or an X-strap. The air purifier 50 is carried on the waist of a worker using the belt and the like while being used, in which the respirator mask 20 and the air purifier 50 are placed on the body of the worker and the air supply tube 30 which connects the respirator mask 20 with the air purifier 50 is installed to use. A change in air flow amount while working such as a blockage caused by a dead battery and an abnormality of a filter or a blockage caused by foreign substances is sensed, and whether the sensed change is present is displayed on the LCD panel 57 to inform the worker of it.

As described above, since there is present a difference between load rates of filter units mounted and installed in air purifiers connected to respirator mask through air supply tubes depending on types thereof, it is necessary for a worker to mount a filter unit appropriate for a workplace and a working condition on an air purifier and simultaneously with inputting and setting a type of the filter unit mounted on the air purifier.

That is, the worker mounts and installs a filter unit different according to the workplace or working condition, for example, the particle removal filter or the odor removal filter in the air purifier and then it is necessary for the worker to directly manually input and set the type of the filter unit installed in the air purifier.

Here, between the particle removal filter and the odor removal filter mounted and installed in the air purifier as the filter unit, the odor removal filter has a higher filtration density than the particle removal filter. Accordingly, when the type of the filter unit mounted and installed in the air purifier is not input and set, a malfunction and error may occur.

That is, when the particle removal filter is mounted in the installation space of the air purifier and then the worker inputs and sets a type as the odor removal filter through the LCD panel of the air purifier, since the particle removal filter having a lower filtration density than the odor removal filter is recognized as the odor removal filter, a load rate is sensed low and the occurrence of an abnormality and an error in the filter unit recognized not to perform purification and filtering of polluted external air is sensed. When the odor removal filter is mounted in the installation space of the air purifier and then the worker inputs and sets a type as the particle removal filter through the LCD panel of the air purifier, since the odor removal filter having the higher filtration density than the particle removal filter is recognized as the particle removal filter, a load rate is sensed high and a blockage phenomenon of the filter unit is sensed.

Due to this, inconveniences in which the worker replaces the filter unit according to an abnormality and error text displayed on the LCD panel may occur and work efficiency is deteriorated, for example, a working time increases.

Meanwhile, a reference life the filter unit mounted and installed in the air purifier is generally determined. When the filter unit passes the reference life, the filter unit mounted in the air purifier is replaced by a new filter unit.

For this, depending on the load rate of the filter unit mounted and installed therein, the air purifier allows the worker to recognize an exchange and replacement time of the filter unit through the LCD panel.

However, as described above, when the input and setting of the worker are wrong and then an error and a malfunction occur in the air purifier due thereto, not only an unnecessary expense occurs, for example, the filter unit which does not pass the reference life is exchanged and replaced but also the environment becomes polluted due to the discarded filter unit.

Also, when it is required to exchange and replace the filter unit due to an abnormality of the filter unit while working, the working is stopped and the filter unit is exchanged and replaced, and simultaneously, the type of the filter unit is input and then the working is performed again, which deteriorates the efficiency and continuity of working.

Also, when an operation of the filter unit is stopped while working in order to allow the worker to recognize the exchange and replacement time of the filter unit, polluted external air is not purified by the air purifier and supplied to the respirator through the air supply tube in such a way that a difficulty in breathing of the wearer who breathes in the polluted air occurs or the wearer is defenselessly exposed to harmful gases.

In addition, when welding fumes are included in the unpurified air, the sweat of the wearer may stick together with the welding fumes onto the periphery of the eyes and respiratory system and may bring about safety accidents such as a visual impairment, damage to skin, pneumoconiosis, etc.

### SUMMARY OF THE INVENTION

It is an aspect of the present invention to provide a structure and method for recognizing information on a filter unit mounted on an air purifier of a respirator, in which the air purifier and the filter unit of the respirator which filters polluted external air and supplies purified air to a worker are wirelessly interconnected in such a way that a control unit of the air purifier may provide the worker with the information on the filter unit such as a type, a load rate depending on a blockage degree of the filter unit, a final operation time, a residual operation time, and a replacement time of the filter unit through information data transmitted from the filter unit. It is possible to precisely recognize the filter unit appropriate for a workplace and a work environment, thereby preventing an error, failure, and malfunction of the filter unit and simultaneously with continuously working.

It is another aspect of the present invention to provide a structure and method for recognizing information on a filter unit mounted on an air purifier of a respirator, in which the air purifier and the filter unit are wirelessly interconnected through radio frequency identification (RFID), wireless fidelity (Wi-Fi), near field communication (NFC), Bluetooth, or Zigbee to detect a type of a filter, to recognize information of the detected filter such as an operation time and life thereof by counting an operation time of the filter, and to allow a wearer to recognize the information.

It is still another aspect of the present invention to provide a structure and method for recognizing information on a filter unit mounted on an air purifier of a respirator, in which information data of the filter unit such as a serial number, a filter type, a final operation time, a residual time, and a replacement time of the filter unit are stored in a control unit when an operation of the filter unit is finished. When the filter unit is mounted in the air purifier to use, the air purifier and the filter unit are wirelessly interconnected to transmit the information data of the filter unit such as the serial number to the air purifier. Based on this, the control unit detects information data of the same type of the filter unit from previously stored information data of the filter unit, and counts from the final operation time. When the operation of the filter unit is finished, information data on the serial number, counted final operation time, changed residual time, etc. is stored in the control unit, thereby allowing a worker to accurately recognize a replacement time of the filter unit. Due to this, the worker may be effectively protected from harmful gases and fine dust such as metal dust and metal fumes, thereby preventing safety accidents in advance and improving work efficiency.

According to an aspect of the present invention, there is provided a structure for recognizing information on a filter unit mounted on an air purifier of a respirator, the structure including the respirator mask put on a worker, the air purifier connected to the respirator mask through an air supply tube and including the filter unit to purify polluted external air flowing thereinto, and a control unit configured to be controllable in the air purifier, in which the air purifier and the filter unit are wirelessly interconnected in such a way that information data of the filter unit is provided to the air purifier.

The air purifier and the filter unit may be wirelessly interconnected through radio frequency identification (RFID), in which an RFID reader is provided in the air purifier, an RFID tag is provided in the filter unit, the information data of the filter unit recorded in the RFID tag of the filter unit is read by the RFID reader of the air purifier, and the information data read by the RFID reader is provided to the control unit.

Alternately, the air purifier and the filter unit may be wirelessly interconnected through one of Wi-Fi, NFC, Bluetooth, and Zigbee in such a way that the information data of the filter unit is provided to the control unit of the air purifier.

When the provided information data of the filter unit, which includes a serial number of the filter unit, is compared with information data previously stored in the control unit and then the filter unit is a previously stored filter unit, the control unit may count from a final operation time while operating and may store information data including a final operation time when the counting is finished, a total operation time, a residual operation time, and a type of a filter unit when the operating is finished.

When the residual operation time is a certain portion of the total operation time or less, the control unit may allow the worker to recognize a replacement time of the filter unit.

When the provided information data of the filter unit, which includes a serial number of the filter unit, is compared with information data previously stored in the control unit and then the filter unit is not a previously stored filter unit, the control unit may count from an initial operation time while operating and may store information data including a final operation time when the counting is finished, a total operation time, a residual operation time, and a type of a filter unit when the operating is finished.

According to another aspect of the present invention, there is provided a method of recognizing information on a filter unit mounted on an air purifier of a respirator in a structure including the respirator mask put on a worker, the air purifier connected to the respirator mask through an air supply tube and including the filter unit to purify polluted external air flowing thereinto, and a control unit provided in the air purifier, the method including mounting and installing the filter unit in the air purifier, wirelessly transmitting information data from the filter unit to the air purifier, providing the control unit with the information data transmitted to the air purifier, checking, by the control unit, whether the transmitted information data of the filter unit is identical to previously stored information data of the filter unit, detecting whether a final operation time of the filter unit mounted on the air purifier reaches a total operation time thereof when the information data of the filter unit is identical to the previously stored information data of the filter unit, counting from the final operation time of the filter unit when the final operation time of the filter unit does not reach the total operation time; and storing, by the control unit, the information data of the filter unit when an operation of the air purifier is finished.

The method may include wirelessly transmitting a serial number from the filter unit to the air purifier through RFID.

The method may include wirelessly transmitting the serial number from the filter unit to the air purifier through one of Wi-Fi, NFC, Bluetooth, and Zigbee.

The method may further include comparing and checking, by the control unit, the transmitted serial number of the filter unit with a previously stored serial number of the filter unit.

The method may further include, when the information data of the filter unit transmitted to the control unit is not identical to the previously stored information data of the filter unit, recognizing the filter unit as a new filter unit and counting from a new operation time of the filter unit.

The method may further include, when the final operation time of the filter unit reaches a certain range of the total operation time, informing a residual operation time and a replacement time of the filter unit.

The method may further include displaying the total operation time, the final operation time, the residual operation time, the replacement time, a guide text, and a replacement and exchange text on a liquid crystal panel of the air purifier to inform of the replacement time of the filter unit, giving, by the air purifier, a warning sound to inform of the replacement time of the filter unit, and turning on and flickering, by the air purifier, a light emitting diode (LED).

The method may further include, when the operation of the air purifier is finished, storing, by the control unit, a serial number, a type, the total operation time, the final operation time, and a residual operation time of the filter unit.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a schematic exploded perspective view of an air purifier of a general respirator;

FIG. 2 schematically illustrates a state in which information on a filter unit is recognized on a liquid crystal display (LCD) panel provided on the air purifier of the respirator of FIG. 1;

FIG. 3 schematically illustrates a state in which information on a particle removal filter mounted in an air purifier of a respirator according to one embodiment of the present invention is recognized;

FIG. 4 schematically illustrates a state in which information on an odor removal filter mounted in the air purifier of the respirator according to one embodiment of the present invention is recognized; and

FIG. 5 is a flowchart of a method of recognizing information on an air purifier of a respirator according to one embodiment of the present invention.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

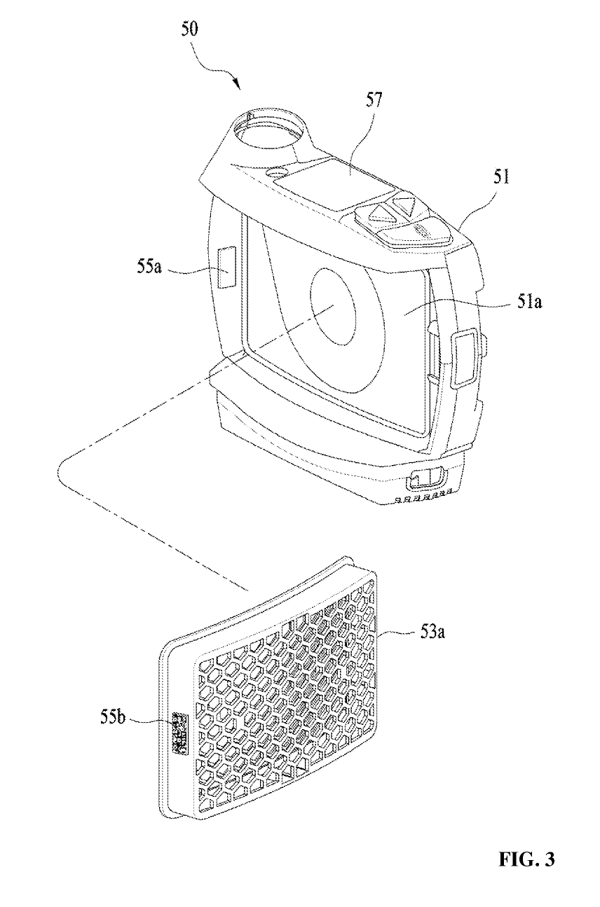

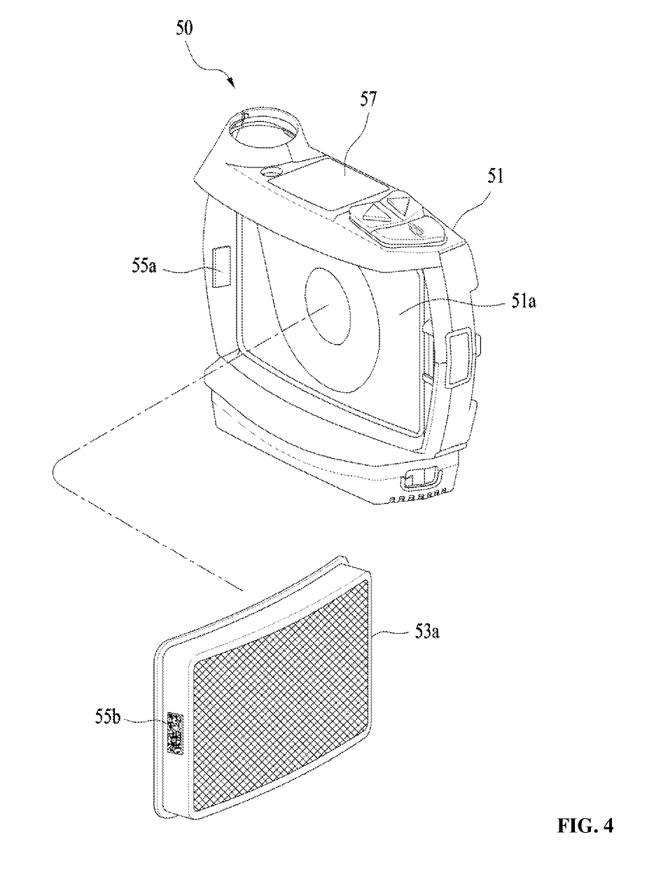

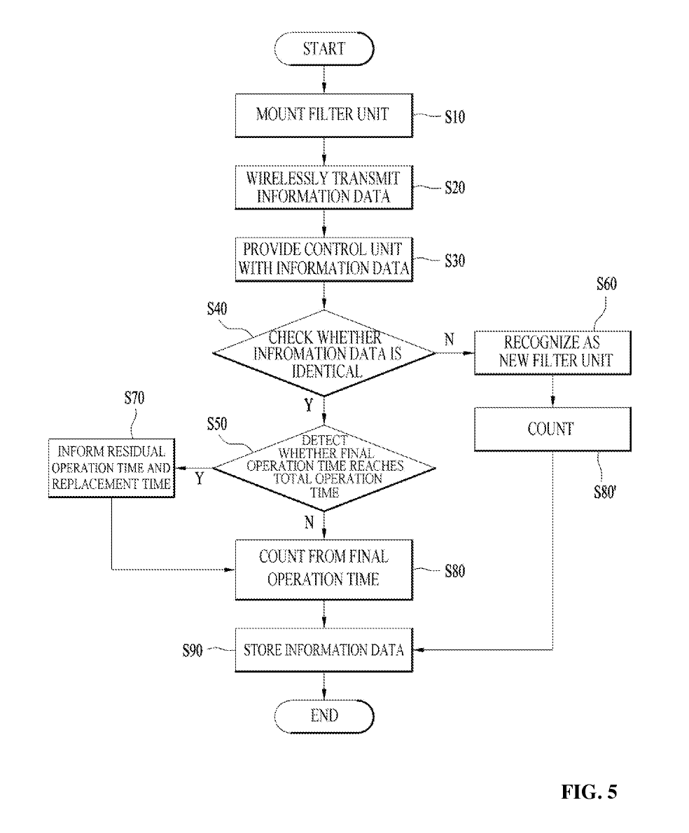

FIG. 3 schematically illustrates a state in which information on a particle removal filter 53a mounted in an air purifier 50 of a respirator 10 according to one embodiment of the present invention is recognized. FIG. 4 schematically illustrates a state in which information on an odor removal filter 53b mounted in the air purifier 50 of the respirator 10 according to one embodiment of the present invention is recognized. FIG. 5 is a flowchart of a method of recognizing information on the air purifier 50 of the respirator 10 according to one embodiment of the present invention.

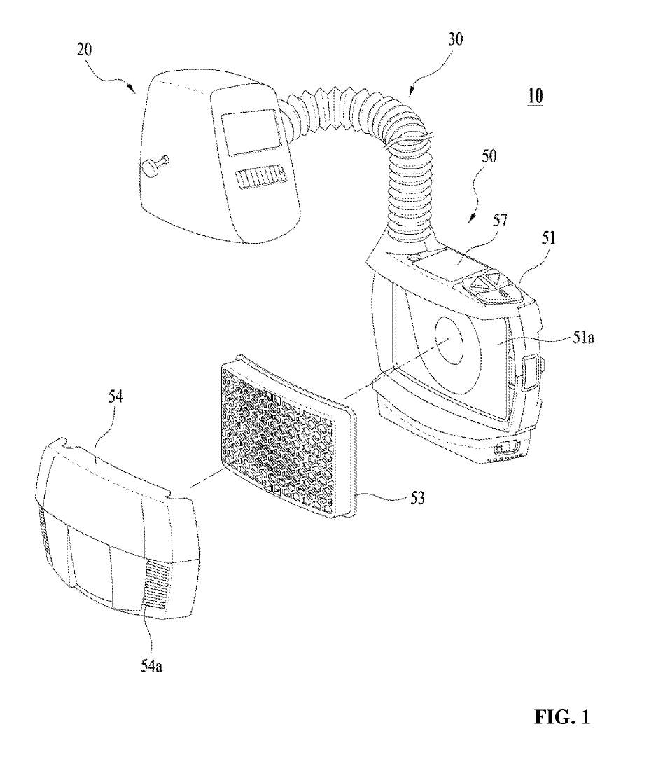

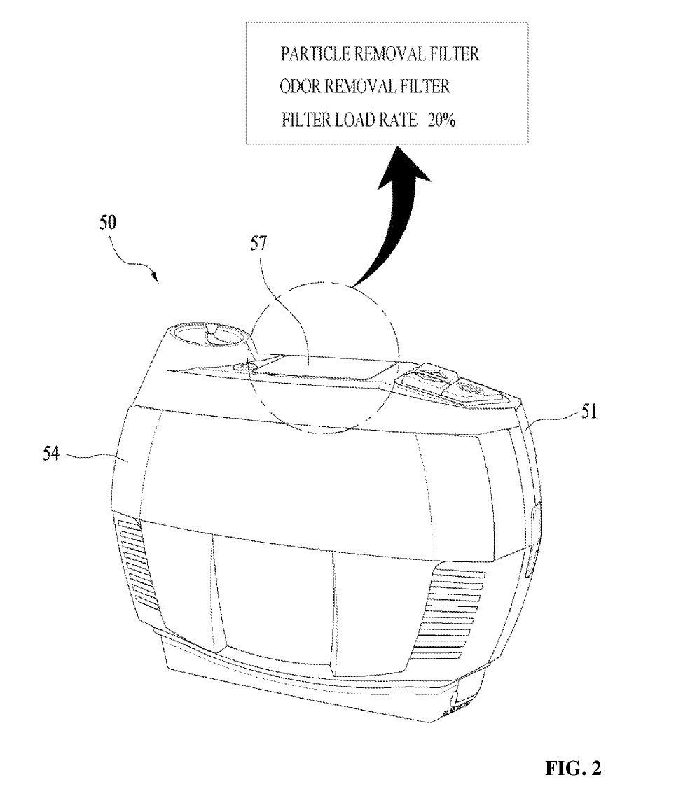

Referring to FIGS. 1 and 2, as shown in the drawings, the respirator 10 according to one embodiment of the present invention is to provide a worker with purified air in an extreme environment and an enclosed space in which particles and harmful odors such as harmful gases, harmful particles, metal dust, and metal fumes occur. The respirator 10 includes the air purifier 50 which purifies polluted external air and is interconnected with the air purifier 50 through an air supply tube 30.

Here, in the case of the air purifier 50, the polluted external air flows thereinto and is purified and then supplied to the respirator mask 20 through the air supply tube 30 to allow the worker to breathe in the purified air supplied to the respirator mask 20 while working, thereby preventing inhalation and inflow of polluted material floating in a workplace through the respiratory system of the worker.

For this, the air purifier 50 includes a body 51 having an installation space 51a inside a front thereof, a filter unit 53 detachably mounted and installed in the installation space 51a of the body 51 to filter and purify polluted air supplied from the outside, and a filter cover 54 coupled with the body 51 to fix the filter unit 53 mounted and installed in the installation space 51a, through which an inlet hole 54a to allow external air to flow therein penetrates.

Here, a pre-filter (not shown) and wire mesh (not shown) are provided on one side of the filter unit 53 to collect particles of pollutants which have relatively larger size and diameter in the air flowing from the outside.

Also, a blower (not shown) which allows the polluted external air to flow into the body 51 of the air purifier 50 and supplies purified air filtered through the filter unit 53 to the respirator mask 20 is provided.

Also, the air purifier 50 is provided with a control unit (not shown) for detecting and controlling a type and a load rate of the filter unit 53 mounted and installed in the installation space 51a of the body 51, and on one side of a top surface of the body 51a liquid crystal display (LCD) panel 57 for displaying the type and load rate of the filter unit 53 detected by the control unit is formed.

With the structure described above, particles and harmful odors such as harmful particles, metal dust, and metal fumes included in the air in a workplace are filtered out and purified air is supplied to a worker who wears the respirator mask 20.

Here, the filter unit 53 includes the particle removal filter 53a and the odor removal filter 53b to allow the worker to insert, mount, and install the filter unit 53 appropriate for a workplace and a working condition into the air purifier 50 in order to purify polluted external air.

As described above, one of the particle removal filter 53a and the odor removal filter 53b, appropriate for the workplace and working condition, is mounted and installed in the installation space 51a formed in the body 51 of the air purifier 50, the pre-filter and the wire mesh are sequentially installed outside one of the particle removal filter 53a and the odor removal filter 53b, and then the filter cover 54 is installed in the body 51 to fix the filter unit 53, the pre-filter, and the wire mesh to the air purifier 50.

As described above, when the filter unit 53 is mounted and installed in the body 51 of the air purifier 50 and then the respirator mask 20 and the air purifier 50 operate, the polluted external air flows into the body 51 of the air purifier 50 through the inlet hole 54a of the filter cover 54 fixedly installed in front of the body 51 of the air purifier 50, particles of pollutants which have relatively larger size and diameter in the polluted external air flowing through the inlet hole 54a of the filter cover 54 are collected through the wire mesh and the pre-filter, and the polluted air passing through the pre-filter is supplied to the filter unit 53 to be filtered and purified, and the purified air is supplied finally to the respirator mask 20 through the air supply tube 30.

In this time, a supply amount of the purified air is controlled for each level, according to the need of the worker wearing the respirator 10, the polluted air is flowed into the body 51 of the air purifier 50, and then the flowed and purified is supplied to the respirator mask 20 by the driving of the blower

Here, when the particle removal filter 53a is applied to the filter unit 53 mounted and installed in the installation space 51a in the body 51 of the air purifier 50, particles of pollutants of the polluted external air flowing into the body 51 through the inlet hole 54a of the filter cover 54 are collected by the wire mesh and the pre-filter, the air passing through the pre-filter is supplied to the particle removal filter 53a, various pollutants, fine dust, and infectious pathogens included in the air are filtered out by the particle removal filter 53a, and the purified air is supplied to the respirator mask 20 through the air supply tube 30.

Here, when the odor removal filter 53b is applied to the filter unit 53 mounted and installed in the installation space 51a in the body 51 of the air purifier 50, particles of pollutants of the polluted external air flowing into the body 51 through the inlet hole 54a of the filter cover 54 are collected by the wire mesh and the pre-filter, the air passing through the pre-filter is supplied to the odor removal filter 53b, hazards such as odors and stench included in the air are filtered out by the odor removal filter 53b, and the purified air is supplied to the respirator mask 20 through the air supply tube 30.

Here, the air purifier 50 is wirelessly interconnected with the filter unit 53 mounted and installed in the body 51 in order to receive various pieces of information on the filter unit 53, information data provided by the filter unit 53 is transmitted to the control unit, and the control unit displays the information data on the LCD panel 57.

For this, the air purifier 50 and the filter unit 53 are wirelessly interconnected through radio frequency identification (RFID) to provide the air purifier 50 with the information data of the filter unit 53.

Here, an RFID tag 55b is provided on one side of the filter unit 53, and an RFID reader 55a is provided in the installation space 51a in the body 51 of the air purifier 50, in which the filter unit 53 is mounted and installed.

As described above, the RFID tag 55b is provided in the filter unit 53 and the RFID reader 55a is provided in the air purifier 50. Accordingly, when the filter unit 53 is mounted and installed in the air purifier 50, the RFID reader 55a and the RFID tag 55b of the filter unit 53 are wirelessly interconnected. The information data of the filter unit 53 recorded in the RFID tag 55b provided in the filter unit 53 is transmitted to the RFID reader 55a included in the air purifier 50.

Meanwhile, information on the type, a serial number, and the manufacturing date of the filter unit 53 is recorded in the RFID tag 55b provided in the filter unit 53 in such a way that when the filter unit 53 is mounted and installed in the installation space 51a in the body 51 of the air purifier 50, the RFID reader 55a receives the information data by reading the RFID tag 55b and transmits the information data of the filter unit 53 to the control unit.

As described above, through the information data of the filter unit 53 transmitted to the control unit, whether the filter unit 53 mounted and installed in the air purifier 50 is the particle removal filter 53a or the odor removal filter 53b is determined and whether the filter unit 53 is previously mounted or newly mounted is determined.

Here, when the control unit determines that the filter unit 53 mounted and installed in the air purifier 50 is previously used, counting is performed from an operation time at a point in time at which an operation is finished, that is, an existing operation time of the filter unit 53, a new operation time is added by counting from the operation time of the filter unit 53 previously used, and a sum of the operation times is stored as a final operation time.

Meanwhile, when the control unit determines that the filter unit 53 mounted and installed in the air purifier 50 is a new one, an operation time of the new filter unit 53 is newly counted and a final operation time at which the using of the filter unit 53 is finished is stored.

That is, when it is determined using the information data of the filter unit 53 received through RFID that a serial number of the filter unit 53 mounted and installed in the air purifier 50 is not a previously stored serial number, the control unit recognizes the filter unit 53 as a new one and newly performs counting, and when the operation of the filter unit 53 is finished, the control unit stores data on the serial number and the final operation time of the new filter unit 53 whose operation is finished.

As described above, when the operations of the respirator mask 20 and the air purifier 50 are finished, the control unit stores the information data on the type, serial number, final operation time, and a residual operation time of the filter unit 53 mounted and installed in the air purifier 50 and used. When the previously used filter unit 53 is mounted in the air purifier 50 and used, the air purifier 50 receives information from the filter unit 53 through the RFID. When the received information data is identical to the information data of the filter unit 53 stored by the control unit, counting starts from the stored final operation time. When the operation of the filter unit 53 is finished, a new operation time is added to the final operation time and a final operation time is stored again, thereby allowing the worker to recognize the type, a total operation time, a residual operation time, and a replacement time of the filter unit 53.

Here, when the residual operation time of the filter unit 53 mounted and installed in the air purifier 50 is a certain portion of the total operation time or less, the air purifier 50 allows the worker to recognize it through the LCD panel 57 or allows the worker to recognize the replacement time of the filter unit 53 through a warning sound of an alarm or through turning on or flickering a light emitting diode (LED).

According to one embodiment of the present invention, the RFID reader 55a is provided in the air purifier 50 and the RFID tag 55b is provided in the filter unit 53 in such a way that the air purifier 50 and the filter unit 53 are wirelessly interconnected through the RFID in order to transmit the information data of the filter unit 53 to the air purifier 50 and then to provide the control unit with the information data. However, the air purifier 50 and the filter unit 53 may be wirelessly interconnected through wireless fidelity (Wi-Fi) in such a way that the information data of the filter unit 53 is transmitted to the air purifier 50 and then transmitted to the control unit.

Also, when the air purifier 50 and the filter unit 53 are interconnected and it is possible to wirelessly transmit the information data of the filter unit 53 to the air purifier 50, the air purifier 50 and the filter unit 53 may be interconnected through one of near field communication (NFC), Bluetooth, and Zigbee.

Here, Wi-Fi is a local area communication network using frequencies or infrared transmission, which is a wireless data transmission system. NFC is a contactless communication technology using a frequency band of 13.56 MHz, which is a local area wireless communication technology capable of reading and writing data and not requiring a dongle (reader). Bluetooth uses a frequency band from 2400 to 2483.5 MHz and is configured to allow communication only between a master device and a slave device. Zigbee is a technology for local area communication and ubiquitous computing, which is local area communication for minimizing power consumption but communicating a small amount of information. Hereinafter, a detailed description thereof will be omitted.

At this time, the information data of the filter unit 53 transmitted from the filter unit 53 to the air purifier 50 is stored by the control unit. The stored information data of the filter unit 53 may include the type, serial number, reference operation time, actual operation time, final operation time, and residual operation time of the filter unit 53. A recent operation time, final operation time, average operation time, maximum operation time, and minimum operation may be stored to allow the worker to recognize the same but it is not limited thereto.

Hereinafter, a method of recognizing information on the filter unit 53 mounted in the air purifier 50 of the respirator 10 according to one embodiment of the present invention will be described.

First, the filter unit 53 is mounted and installed in the air purifier 50 connected to the respirator mask 20 through the air supply tube 30, and the air purifier 50 is turned on to drive.

Here, the information data of the filter unit 53 is wirelessly transmitted to the air purifier 50.

Here, the information data of the filter unit 53 is transmitted to the air purifier 50 through RFID. That is, the information data such as a serial number of the filter unit 53 recorded in the RFID tag 55b of the filter unit 53 is read by the RFID reader 55a of the air purifier 50.

As described above, the information data of the filter unit 53 read by the RFID reader 55a of the air purifier 50 is provided to the control unit, and the control unit checks whether the provided information data of the filter unit 53 is identical to information data of the filter unit 53 previously stored in the control unit through comparison.

That is, the control unit detects whether the filter unit 53 mounted and installed in the air purifier 50 is the particle removal filter 53a or the odor removal filter 53b through the information data such as the serial number provided by the RFID reader 55a and simultaneously checks whether the filter unit 53 is previously mounted and used, which is previously stored in the control unit, or is a new one that is not mounted and used before.

According to one embodiment of the present invention, the air purifier 50 and the filter unit 53 are wirelessly interconnected through RFID in order to transmit the information data of the filter unit 53 to the air purifier 50. However, the air purifier 50 and the filter unit 53 may be wirelessly interconnected through Wi-Fi to transmit the information data of the filter unit 53 to the air purifier 50.

Also, the air purifier 50 and the filter unit 53 may be wirelessly interconnected through one of NFC, Bluetooth, and Zigbee in order to transmit the information data of the filter unit 53 to the air purifier 50.

Here, when the information data of the filter unit 53 mounted in the air purifier 50 is identical to the information data of the previously used filter unit 53 previously stored in the control unit, the control unit checks whether a final operation time of the filter unit 53 mounted in the air purifier 50 reaches a total operation time set when manufactured.

Here, when the final operation time of the filter unit 53 reaches the total operation time, the worker is informed through a message, a warning sound, or flickering of an LED that the total operation time of the filter unit 53 is finished and it is necessary to exchange and replace with a new filter unit 53.

Meanwhile, when the final operation time of the filter unit 53 does not reach the total operation time, the final operation time and residual operation time of the filter unit 53 are detected and displayed on the LCD panel 57 to allow the worker to recognize the operation time of the filter unit 53.

As described above, when the filter unit 53 mounted and installed in the air purifier 50 is previously stored in the control unit but available, counting is performed and starts from the final operation time while working and the serial number, the counted final operation time, and residual operation time of the filter unit 53 are stored in the control unit when the operation is finished.

Meanwhile, when the stored final operation time and residual operation time reach and are close to the total operation time, the control unit allows the worker to recognize a replacement time of the filter unit 53. That is, when the stored final operation time reaches and is close to a certain range of the total operation time, the control unit displays the final operation time, residual operation time, and exchange and replacement time of the filter unit 53 to allow the worker to recognize the same.

According to one embodiment of the present invention, the residual operation time and exchange and replacement time of the filter unit 53 are displayed on the LCD panel 57 of the air purifier 50. However, texts for guide, replacement, and exchange of the filter unit 53 may be displayed on the LCD panel 57, a warning sound such as an alarm may be given, and an LED may be turned on or may repetitively flicker.

Here, the exchange and replacement time of the filter unit 53 may be set to be within a range from 5 to 10% of the total operation time but may be arbitrarily set by the worker depending on a working condition such as a workplace and a work environment. The exchange and replacement time of the filter unit 53 may be variously changeable.

Meanwhile, when the filter unit 53 mounted on the air purifier 50 is not previously used and not stored in the control unit, the control unit recognizes the filter unit 53 as a new one, counts from the beginning, and stores a serial number, a counted final operation time, and a residual operation time of the filter unit 53 when the operation of the filter unit 53 is finished.

Here, when the final operation time of the new filter unit 53 mounted in the air purifier 50 reaches and is closed to a certain range of a total operation time thereof, the residual operation time and exchange and replacement time are displayed on the LCD panel 57 to be informed to the worker.

For example, the filter unit 53 is the particle removal filter 53a whose total operation time is 500 hours and final operation time is 300 hours and is mounted and installed in the installation space 51a of the air purifier 50 connected to the respirator 10 through the air supply tube 30. When the air purifier 50 is turned on and used, the RFID tag 55b included in the filter unit 53 is read by the RFID reader 55a of the air purifier 50 and information data of the filter unit 53 read by the RFID reader 55a is transmitted to the control unit.

The control unit detects whether the filter unit 53 is previously used and simultaneously detects a type of the filter unit 53 by comparing and checking the serial number of the filter unit 53 transmitted and provided through RFID with a previously stored serial number of the filter unit 53.

As described above, when the control unit checks that the filter unit 53 is previously used and the total operation time, final operation time, and residual operation time thereof are stored, in which the total operation time is 500 hours and the final operation time is 300 hours, counting starts from 300 hours which is the final operation time of the filter unit 53 and the air purifier 50 is turned off after operating for 8 hours, the control unit stores the serial number of the filter unit 53 mounted on the air purifier 50 and simultaneously stores the filter unit 53 as the particle removal filter 53a, stores the total operation time, final operation time, and residual operation time of the particle removal filter 53a as 500 hours, 308 hours, and 182 hours, respectively.

As described above, in the information data of the filter unit 53 stored in the control unit, counting starts from the final operation time when the air purifier 50 is turned on to use the filter unit 53, that is, counting starts from 308 hours at a next time of using the filter unit 53, and the serial number, total operation time, final operation time, and residual operation time are stored when the air purifier 50 is turned off to finish the operation of the filter unit 53.

Meanwhile, the filter unit 53 is the odor removal filter 53b whose total operation time is 500 hours and is mounted and installed in the installation space 51a of the body 51 of the air purifier 50. When the air purifier 50 is turned on and used, the RFID tag 55b included in the filter unit 53 is read by the RFID reader 55a of the air purifier 50 and information data of the filter unit 53 read by the RFID reader 55a is transmitted to the control unit.

The control unit compares and checks the serial number of the filter unit 53 transmitted and provided through RFID with a previously stored serial number of the filter unit 53 and recognizes that the filter unit 53 is newly mounted.

As described above, when the control unit confirms that the filter unit 53 is a new one which is not previously used, counting starts from 0. When the air purifier 50 is turned off to finish the operation of the filter unit 53 after operating for 4 hours, the control unit newly stores a serial number of the filter unit 53 mounted in the air purifier 50 and simultaneously stores the filter unit 53 as the odor removal filter 53b and stores a total operation time, final operation time, and residual operation time of the odor removal filter 53b as 500 hours, 4 hours, and 496 hours, respectively.

Meanwhile, when the residual operation time of the filter unit 53 is a certain time or less, an exchange text is displayed on the LCD panel 57 of the air purifier 50, a warning sound is given, or an LED is turned on and flickers to allow the worker to recognize a replacement and exchange time of the filter unit 53.

That is, when the final operation time of the filter unit 53 whose total operation time is 500 hours is detected as being 475 hours or more, the control unit displays the total operation time, final operation time, and residual operation time of the filter unit 53 through the LCD panel 57 of the air purifier 50 and simultaneously displays texts for guide, replacement, and exchange of the filter unit 53, gives a warning sound such as an alarm, turns on or repetitively flickers an LED to allow the worker to recognize the replacement and exchange time of the filter unit 53.

Here, the replacement and exchange time of the filter unit 53 may be informed to the worker when the residual operation time of the filter unit 53 is 5% or less of the total operation time. However, the replacement and exchange time of the filter unit 53 may be allowed to be recognized by the worker when the residual operation time of the filter unit 53 is from 1% to 30% or may be variously set by arbitrary operating and setting of the worker.

As described above, according to the embodiments of the present invention, an air purifier and a filter unit are wirelessly interconnected through RFID, Wi-Fi, NFC, Bluetooth, or Zigbee in such a way that wrong recognition of a filter unit and replacement and exchange of an expired filter unit are guided to prevent safety accidents in advance. Additional operation, input, setting, and control according to a type of a filter unit are not necessary when the filter unit is mounted, which is simple and easy to use.

Also, information data such as a filter type, final operation time, and residual operation time according to a serial number of the filter unit is consistently updated by a control unit when the air purifier is used. Accordingly, a life and replacement time of the filter unit are provided to the worker. It is possible to accurately recognize a filter unit appropriate for a workplace and work environment, thereby accurately sensing a load rate of the filter unit according to a blockage degree of the filter unit. Due to this, a malfunction and error are prevented and the filter unit is allowed to accurately operate to provide an excellent filtering effect of purifying polluted external air. Accordingly, it is possible to continue working and there is provided an effect of effectively collecting harmful gases and fine dust such as metal particles and metal fumes.

Also, damage caused by fine dust in the air in an extreme environment and enclosed workplace may be minimized and simultaneously the respiratory system of the worker may be effectively protected, which is industrially useful. It is possible not only to easily check information on the filter unit while working but also to accurately recognize the information to perform a follow-up, to prevent an abnormality, error, and malfunction of the filter unit, and to improve work efficiency.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A structure for recognizing information on a filter unit mounted on an air purifier of a respirator, the respirator including the respirator mask put on a worker, the air purifier connected to the respirator mask through an air supply tube and including the filter unit to purify polluted external air flowing thereinto, and a control unit configured to be controllable in the air purifier, comprising
wherein the air purifier and the filter unit are wirelessly interconnected in such a way that information data of the filter unit is provided to the air purifier.

2. The structure of claim 1, wherein the air purifier and the filter unit are wirelessly interconnected through radio frequency identification (RFID), in which an RFID reader is provided in the air purifier, an RFID tag is provided in the filter unit, the information data of the filter unit recorded in the RFID tag of the filter unit is read by the RFID reader of the air purifier, and the information data read by the RFID reader is provided to the control unit.

3. The structure of claim 1, wherein the air purifier and the filter unit are wirelessly interconnected through one of wireless fidelity (Wi-Fi), near field communication (NFC), Bluetooth, and Zigbee in such a way that the information data of the filter unit is provided to the control unit of the air purifier.

4. The structure according to any one of claims 2 and 3, wherein when the provided information data of the filter unit, which comprises a serial number of the filter unit, is compared with information data previously stored in the control unit and then the filter unit is a previously stored filter unit, the control unit counts from a final operation time while operating and stores information data including a final operation time when the counting is finished, a total operation time, and a residual operation time, and a type of the filter unit when the operating is finished.

5. The structure of claim 4, wherein when the residual operation time is a certain portion of the total operation time or less, the control unit allows the worker to recognize a replacement time of the filter unit.

6. The structure according to any one of claims 2 and 3, wherein when the provided information data of the filter unit, which includes a serial number of the filter unit, is compared with information data previously stored in the control unit and then the filter unit is not a previously stored filter unit, the control unit counts from an initial operation time while operating and stores information data including a final operation time when the counting is finished, a total operation time, a residual operation time, and a type of the filter unit when the operating is finished.

7. A method of recognizing information on a filter unit mounted on an air purifier of a respirator including the respirator mask put on a worker, the air purifier connected to the respirator mask through an air supply tube and including the filter unit to purify polluted external air flowing thereinto, and a control unit provided in the air purifier, the method comprising:
mounting and installing the filter unit in the air purifier;
wirelessly transmitting information data from the filter unit to the air purifier;
providing the control unit with the information data transmitted to the air purifier;
checking, by the control unit, whether the transmitted information data of the filter unit is identical to previously stored information data of the filter unit;
detecting whether a final operation time of the filter unit mounted on the air purifier reaches a total operation time thereof when the information data of the filter unit is identical to the previously stored information data of the filter unit;
counting from the final operation time of the filter unit when the final operation time of the filter unit does not reach the total operation time; and
storing, by the control unit, the information data of the filter unit when an operation of the air purifier is finished.

8. The method of claim 7, comprising wirelessly transmitting a serial number from the filter unit to the air purifier through RFID.

9. The method of claim 7, comprising wirelessly transmitting a serial number from the filter unit to the air purifier through one of Wi-Fi, NFC, Bluetooth, and Zigbee.

10. The method of claim 7, further comprising comparing and checking, by the control unit, the transmitted information data of the filter unit with a previously stored serial number of the filter unit.

11. The method of claim 7, further comprising, when the information data of the filter unit transmitted to the control unit is not identical to the previously stored information data of the filter unit:
recognizing the filter unit as a new filter unit; and
counting from a new operation time of the filter unit.

12. The method of claim 7, further comprising, when the final operation time of the filter unit reaches a certain range of the total operation time, informing a residual operation time and a replacement time of the filter unit.

13. The method of claim 12, further comprising:
displaying the total operation time, the final operation time, the residual operation time, the replacement time, a guide text, and a replacement and exchange text on a liquid crystal panel of the air purifier to inform of the replacement time of the filter unit;
giving, by the air purifier, a warning sound to inform of the replacement time of the filter unit; and
turning on and flickering, by the air purifier, a light emitting diode (LED).

14. The method of claim 7, further comprising, when the operation of the air purifier is finished, storing, by the control unit, a serial number, a type, the total operation time, the final operation time, and a residual operation time of the filter unit.
